(19) United States
(12) Patent Application Publication
(10) Pub. No.: US 2009/0274383 A1
(43) Pub. Date: Nov. 5, 2009

(54) SYSTEM AND METHOD FOR GLOBAL IMAGE ENHANCEMENT OF DARKENED IMAGE

(76) Inventors: Jonathan YEN, San Jose, CA (US); William C. Kress, Vista, CA (US)

Correspondence Address: TUCKER ELLIS & WEST LLP, 1150 HUNTINGTON BUILDING, 925 EUCLID AVENUE, CLEVELAND, OH, 44115-1414, US

(21) Appl. No.: 12/114,089

(22) Filed: May 2, 2008

(51) Int. Cl. G06K 9/40

(52) U.S. Cl. 382/254

(57) ABSTRACT

The subject application is directed to a system and method for global darkness image enhancement. Image data encoded in a multidimensional color space is first acquired. Thereafter, histogram data is calculated according to the acquired image data. A ramp zone associated with the calculated histogram data is then detected. A black level associated with the acquired image data is then selectively stretched in accordance with the detected ramp zone so as to generate enhanced image data. The enhanced image data is then output to an associated data storage or an associated display.

### BACKGROUND OF THE INVENTION

The subject application is generally directed to enhancement of digitally encoded images. The application is particularly suited to automatically improving an appearance of rendered electronic images by selectively stretching a black level associated with image data.

Electronic images include those images acquired by digital camera, or other image capture or acquisition systems. Often times acquired images appear to be more washed out or lacking in definition given the circumstances during which an image was obtained. Factors affecting image appearance includes lighting levels, lighting position, balance of colors, and proximity of objects and size of objects in a captured image. Many acquired images can be improved by adjusting various image properties through software-based data manipulation. Applications, such as Adobe Photoshop, include controls such as a slider control which enables a user to manually adjust a brightness or darkness of an image by adjustment of its image data, typically stored as in a multidimensional color space such as RGB, CMYK, or any other multidimensional color system.

While image adjustment by brightness control can improve a rendered image, there is substantial opportunity for inexact adjustment of brightness or darkness given the parameters that are adjustable and that humans are involved in the process.

### SUMMARY OF THE INVENTION

In accordance with one embodiment of the subject application, there is provided a system and method for enhancement of digitally encoded images.

Further in accordance with one embodiment of the subject application, there is provided a system and method for automatically improving an appearance of rendered electronic images by selectively stretching a black level associated with image data.

Still further in accordance with one embodiment of the subject application, there is provided a global darkness image enhancement system. The system comprises means adapted for acquiring image data encoded in a multidimensional color space and means adapted for calculating histogram data in accordance with acquired image data. The system also comprises means adapted for detecting a ramp zone associated with calculated histogram data and enhancement means adapted for selectively stretching a black level associated with the acquired image data in accordance with a detected ramp zone so as to generate enhanced image data. The system further comprises means adapted for outputting enhanced image data to at least one of an associated data storage and an associated display.

Further in accordance with one embodiment of the subject application, there is provided a global darkness image enhancement method. The method includes the step of acquiring image data encoded in a multidimensional color space. The method also includes the step of calculating histogram data in accordance with acquired image data. The method further comprises the steps of detecting a ramp zone associated with the calculated histogram data, and selectively stretching a black level associated with the acquired image data in accordance with a detected ramp zone so as to generate enhanced image data. The method also comprises the step of outputting enhanced image data to at least one of an associated data storage and an associated display.

Still other advantages, aspects and features of the subject application will become readily apparent to those skilled in the art from the following description wherein there is shown and described a preferred embodiment of the subject application, simply by way of illustration of one of the best modes best suited to carry out the subject application. As it will be realized, the subject application is capable of other different embodiments and its several details are capable of modifications in various obvious aspects all without departing from the scope of the subject application. Accordingly, the drawings and descriptions will be regarded as illustrative in nature and not as restrictive.

### BRIEF DESCRIPTION OF THE DRAWINGS

The subject application is described with reference to certain figures, including:

FIG. 1 is an overall diagram of a system for global darkness image enhancement according to one embodiment of the subject application;

FIG. 2 is a block diagram illustrating controller hardware for use in the system for global darkness image enhancement according to one embodiment of the subject application;

FIG. 3 is a functional diagram illustrating the controller for use in the system for global darkness image enhancement according to one embodiment of the subject application;

FIG. 4A is an example input image requiring global darkness image enhancement in accordance with one embodiment of the subject application;

FIG. 4B is an example input image after global darkness image enhancement in accordance with one embodiment of the subject application;

FIG. 5A is an example input image and calculated histogram requiring global darkness image enhancement in accordance with one embodiment of the subject application;

FIG. 5B is an example input image and calculated histogram after global darkness image enhancement in accordance with one embodiment of the subject application;

FIG. 6 is an example input image and calculated histogram requiring global darkness image enhancement in accordance with one embodiment of the subject application;

FIG. 7 is a normalized histogram of the example input image of FIG. 6 requiring global darkness image enhancement in accordance with one embodiment of the subject application;

FIG. 8 is close-up view of a ramp of the normalized histogram of the example input image of FIG. 7 requiring global darkness image enhancement in accordance with one embodiment of the subject application;

FIG. 9A is an example input image requiring global darkness image enhancement in accordance with one embodiment of the subject application;

FIG. 9B is an example input image after global darkness image enhancement in accordance with one embodiment of the subject application;

FIG. 10 is a normalize histogram of the example input image of FIG. 9A requiring global darkness image enhancement in accordance with one embodiment of the subject application;

FIG. 11 is close-up view of a ramp of the normalized histogram of the example input image of FIG. 10 requiring global darkness image enhancement in accordance with one embodiment of the subject application;

FIG. 12 is close-up view of a ramp of the normalized histogram with backward difference applied of the example input image of FIG. 10 requiring global darkness image enhancement in accordance with one embodiment of the subject application;

FIG. 13 is a detailed view of the ramp of the normalized histogram with backward difference applied of the example input image of FIG. 10 requiring global darkness image enhancement in accordance with one embodiment of the subject application;

FIG. 14 is a plot of ramp stop versus amount of black stretch in ground truth for use in the system and method for global darkness image enhancement in accordance with one embodiment of the subject application;

FIG. 15A illustrates the correlation between the ramp stop and amount of black stretch in ground truth in linear, quadratic, and cubic fitting functions for use in the system and method for global darkness image enhancement in accordance with one embodiment of the subject application;

FIG. 15B illustrates the residuals of ramp stop and amount of black stretch in ground truth in the linear, quadratic, and cubic fitting functions of FIG. 15A used in the system and method for global darkness image enhancement in accordance with one embodiment of the subject application;

FIG. 16 illustrates a piece-wise linear fitting function for use in the system and method for global darkness image enhancement in accordance with one embodiment of the subject application;

FIG. 17 is a first example input image and calculated histogram not requiring global darkness image enhancement in accordance with one embodiment of the subject application;

FIG. 18 is a second example input image and calculated histogram not requiring global darkness image enhancement in accordance with one embodiment of the subject application;

FIG. 19 is a third example input image and calculated histogram not requiring global darkness image enhancement in accordance with one embodiment of the subject application;

FIG. 20 is a flowchart illustrating a method for global darkness image enhancement according to one embodiment of the subject application; and

FIG. 21 is a flowchart illustrating a method for global darkness image enhancement according to one embodiment of the subject application.

### DETAILED DESCRIPTION OF THE PREFERRED EMBODIMENT

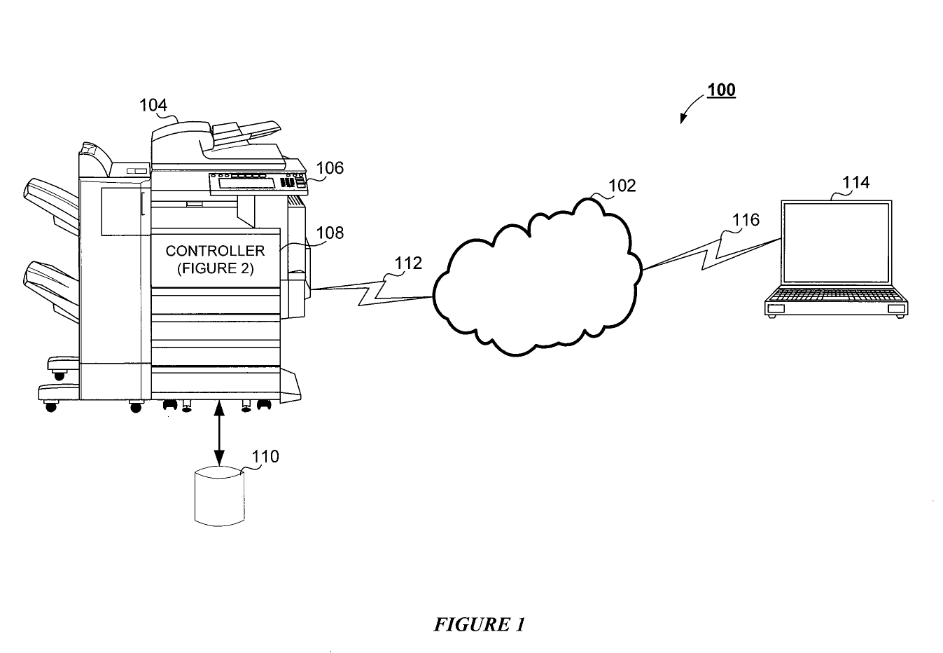

The subject application is directed to a system and method for enhancement of digitally encoded images. In particular, the subject application is directed to a system and method for automatically improving an appearance of rendered electronic images by selectively stretching a black level associated with image data. More particularly, the subject application is directed to a system and method for global darkness image enhancement. It will become apparent to those skilled in the art that the system and method described herein are suitably adapted to a plurality of varying electronic fields employing image enhancement, including, for example and without limitation, communications, general computing, data processing, document processing, or the like. The preferred embodiment, as depicted in FIG. 1, illustrates a document processing field for example purposes only and is not a limitation of the subject application solely to such a field.

Referring now to FIG. 1, there is shown an overall diagram of a system 100 for global darkness image enhancement in accordance with one embodiment of the subject application. As shown in FIG. 1, the system 100 is capable of implementation using a distributed computing environment, illustrated as a computer network 102. It will be appreciated by those skilled in the art that the computer network 102 is any distributed communications system known in the art capable of enabling the exchange of data between two or more electronic devices. The skilled artisan will further appreciate that the computer network 102 includes, for example and without limitation, a virtual local area network, a wide area network, a personal area network, a local area network, the Internet, an intranet, or any suitable combination thereof. In accordance with the preferred embodiment of the subject application, the computer network 102 is comprised of physical layers and transport layers, as illustrated by the myriad of conventional data transport mechanisms, such as, for example and without limitation, Token-Ring, 802.11(x), Ethernet, or other wireless or wire-based data communication mechanisms. The skilled artisan will appreciate that while a computer network 102 is shown in FIG. 1, the subject application is equally capable of use in a stand-alone system, as will be known in the art.

The system 100 also includes a document processing device 104, depicted in FIG. 1 as a multifunction peripheral device, suitably adapted to perform a variety of document processing operations. It will be appreciated by those skilled in the art that such document processing operations include, for example and without limitation, facsimile, scanning, copying, printing, electronic mail, document management, document storage, or the like. Suitable commercially available document processing devices include, for example and without limitation, the Toshiba e-Studio Series Controller. In accordance with one aspect of the subject application, the document processing device 104 is suitably adapted to provide remote document processing services to external or network devices. Preferably, the document processing device 104 includes hardware, software, and any suitable combination thereof, configured to interact with an associated user, a networked device, or the like.

According to one embodiment of the subject application, the document processing device 104 is suitably equipped to receive a plurality of portable storage media, including, without limitation, Firewire drive, USB drive, SD, MMC, XD, Compact Flash, Memory Stick, and the like. In the preferred embodiment of the subject application, the document processing device 104 further includes an associated user interface 106, such as a touch-screen, LCD display, touch-panel, alpha-numeric keypad, or the like, via which an associated user is able to interact directly with the document processing device 104. In accordance with the preferred embodiment of the subject application, the user interface 106 is advantageously used to communicate information to the associated user and receive selections from the associated user. The skilled artisan will appreciate that the user interface 106 comprises various components, suitably adapted to present data to the associated user, as are known in the art. In accordance with one embodiment of the subject application, the user interface 106 comprises a display, suitably adapted to display one or more graphical elements, text data, images, or the like, to an associated user, receive input from the associated user, and communicate the same to a backend component, such as a controller 108, as explained in greater detail below. Preferably, the document processing device 104 is communicatively coupled to the computer network 102 via a suitable communications link 112. As will be understood by those skilled in the art, suitable communications links include, for example and without limitation, WiMax, 802.11a, 802.11b, 802.11g, 802.11(x), Bluetooth, the public switched telephone network, a proprietary communications network, infrared, optical, or any other suitable wired or wireless data transmission communications known in the art.

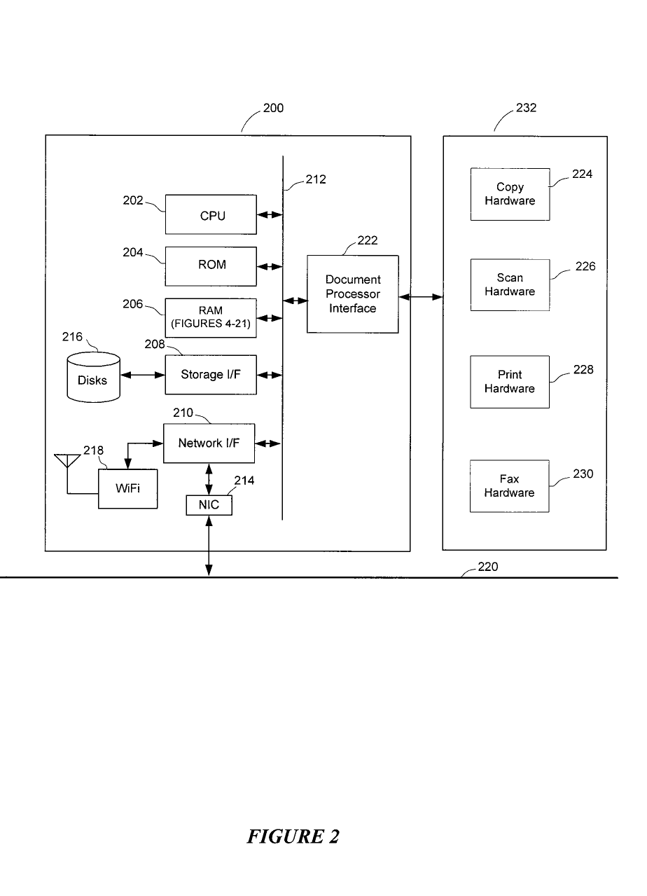

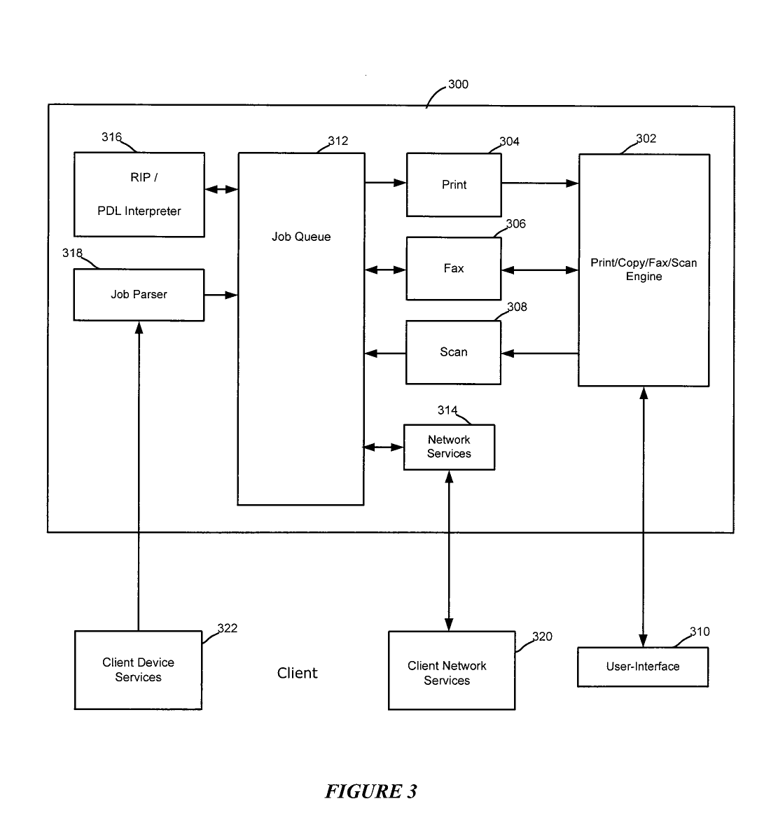

In accordance with one embodiment of the subject application, the document processing device 104 further incorporates a backend component, designated as the controller 108, suitably adapted to facilitate the operations of the document processing device 104, as will be understood by those skilled in the art. Preferably, the controller 108 is embodied as hardware, software, or any suitable combination thereof, configured to control the operations of the associated document processing device 104, facilitate the display of images via the user interface 106, direct the manipulation of electronic image data, and the like. For purposes of explanation, the controller 108 is used to refer to any myriad of components associated with the document processing device 104, including hardware, software, or combinations thereof, functioning to perform, cause to be performed, control, or otherwise direct the methodologies described hereinafter. It will be understood by those skilled in the art that the methodologies described with respect to the controller 108 are capable of being performed by any general purpose computing system, known in the art, and thus the controller 108 is representative of such a general computing device and is intended as such when used hereinafter. Furthermore, the use of the controller 108 hereinafter is for the example embodiment only, and other embodiments, which will be apparent to one skilled in the art, are capable of employing the system and method for global darkness image enhancement of the subject application. The functioning of the controller 108 will better be understood in conjunction with the block diagrams illustrated in FIGS. 2 and 3, explained in greater detail below.

Communicatively coupled to the document processing device 104 is a data storage device 110. In accordance with the preferred embodiment of the subject application, the data storage device 110 is any mass storage device known in the art including, for example and without limitation, magnetic storage drives, a hard disk drive, optical storage devices, flash memory devices, or any suitable combination thereof. In the preferred embodiment, the data storage device 110 is suitably adapted to store document data, image data, electronic database data, or the like. It will be appreciated by those skilled in the art that while illustrated in FIG. 1 as being a separate component of the system 100, the data storage device 110 is capable of being implemented as internal storage component of the document processing device 104, a component of the controller 108, or the like, such as, for example and without limitation, an internal hard disk drive, or the like.

The system 100 illustrated in FIG. 1 further depicts a user device 114, in data communication with the computer network 102 via a communications link 116. It will be appreciated by those skilled in the art that the user device 114 is shown in FIG. 1 as a laptop computer for illustration purposes only. As will be understood by those skilled in the art, the user device 114 is representative of any personal computing device known in the art, including, for example and without limitation, a computer workstation, a personal computer, a personal data assistant, a web-enabled cellular telephone, a smart phone, a proprietary network device, or other web-enabled electronic device. The communications link 116 is any suitable channel of data communications known in the art including, but not limited to wireless communications, for example and without limitation, Bluetooth, WiMax, 802.11a, 802.11b, 802.11g, 802.11(x), a proprietary communications network, infrared, optical, the public switched telephone network, or any suitable wireless data transmission system, or wired communications known in the art. Preferably, the user device 114 is suitably adapted to generate and transmit electronic documents, document processing instructions, user interface modifications, upgrades, updates, personalization data, or the like, to the document processing device 104, or any other similar device coupled to the computer network 102.

Turning now to FIG. 2, illustrated is a representative architecture of a suitable backend component, i.e., the controller 200, shown in FIG. 1 as the controller 108, on which operations of the subject system 100 are completed. The skilled artisan will understand that the controller 200 is representative of any general computing device, known in the art, capable of facilitating the methodologies described herein. Included is a processor 202, suitably comprised of a central processor unit. However, it will be appreciated that processor 202 may advantageously be composed of multiple processors working in concert with one another as will be appreciated by one of ordinary skill in the art. Also included is a non-volatile or read only memory 204 which is advantageously used for static or fixed data or instructions, such as BIOS functions, system functions, system configuration data, and other routines or data used for operation of the controller 200.

Also included in the controller 200 is random access memory 206, suitably formed of dynamic random access memory, static random access memory, or any other suitable, addressable and writable memory system. Random access memory provides a storage area for data instructions associated with applications and data handling accomplished by processor 202.

A storage interface 208 suitably provides a mechanism for non-volatile, bulk or long term storage of data associated with the controller 200. The storage interface 208 suitably uses bulk storage, such as any suitable addressable or serial storage, such as a disk, optical, tape drive and the like as shown as 216, as well as any suitable storage medium as will be appreciated by one of ordinary skill in the art.

A network interface subsystem 210 suitably routes input and output from an associated network allowing the controller 200 to communicate to other devices. The network interface subsystem 210 suitably interfaces with one or more connections with external devices to the device 200. By way of example, illustrated is at least one network interface card 214 for data communication with fixed or wired networks, such as Ethernet, token ring, and the like, and a wireless interface 218, suitably adapted for wireless communication via means such as WiFi, WiMax, wireless modem, cellular network, or any suitable wireless communication system. It is to be appreciated however, that the network interface subsystem suitably utilizes any physical or non-physical data transfer layer or protocol layer as will be appreciated by one of ordinary skill in the art. In the illustration, the network interface 214 is interconnected for data interchange via a physical network 220, suitably comprised of a local area network, wide area network, or a combination thereof.

Data communication between the processor 202, read only memory 204, random access memory 206, storage interface 208 and the network interface subsystem 210 is suitably accomplished via a bus data transfer mechanism, such as illustrated by the bus 212.

Also in data communication with the bus 212 is a document processor interface 222. The document processor interface 222 suitably provides connection with hardware 232 to perform one or more document processing operations. Such operations include copying accomplished via copy hardware 224, scanning accomplished via scan hardware 226, printing accomplished via print hardware 228, and facsimile communication accomplished via facsimile hardware 230. It is to be appreciated that the controller 200 suitably operates any or all of the aforementioned document processing operations. Systems accomplishing more than one document processing operation are commonly referred to as multifunction peripherals or multifunction devices.

Functionality of the subject system 100 is accomplished on a suitable document processing device, such as the document processing device 104, which includes the controller 200 of FIG. 2, (shown in FIG. 1 as the controller 108) as an intelligent subsystem associated with a document processing device. In the illustration of FIG. 3, controller function 300 in the preferred embodiment, includes a document processing engine 302. A suitable controller functionality is that incorporated into the Toshiba e-Studio system in the preferred embodiment. FIG. 3 illustrates suitable functionality of the hardware of FIG. 2 in connection with software and operating system functionality as will be appreciated by one of ordinary skill in the art.

In the preferred embodiment, the engine 302 allows for printing operations, copy operations, facsimile operations and scanning operations. This functionality is frequently associated with multi-function peripherals, which have become a document processing peripheral of choice in the industry. It will be appreciated, however, that the subject controller does not have to have all such capabilities. Controllers are also advantageously employed in dedicated or more limited purposes document processing devices that perform one or more of the document processing operations listed above.

The engine 302 is suitably interfaced to a user interface panel 310, which panel allows for a user or administrator to access functionality controlled by the engine 302. Access is suitably enabled via an interface local to the controller, or remotely via a remote thin or thick client.

The engine 302 is in data communication with the print function 304, facsimile function 306, and scan function 308. These functions facilitate the actual operation of printing, facsimile transmission and reception, and document scanning for use in securing document images for copying or generating electronic versions.

A job queue 312 is suitably in data communication with the print function 304, facsimile function 306, and scan function 308. It will be appreciated that various image forms, such as bit map, page description language or vector format, and the like, are suitably relayed from the scan function 308 for subsequent handling via the job queue 312.

The job queue 312 is also in data communication with network services 314. In a preferred embodiment, job control, status data, or electronic document data is exchanged between the job queue 312 and the network services 314. Thus, suitable interface is provided for network based access to the controller function 300 via client side network services 320, which is any suitable thin or thick client. In the preferred embodiment, the web services access is suitably accomplished via a hypertext transfer protocol, file transfer protocol, uniform data diagram protocol, or any other suitable exchange mechanism. The network services 314 also advantageously supplies data interchange with client side services 320 for communication via FTP, electronic mail, TELNET, or the like. Thus, the controller function 300 facilitates output or receipt of electronic document and user information via various network access mechanisms.

The job queue 312 is also advantageously placed in data communication with an image processor 316. The image processor 316 is suitably a raster image process, page description language interpreter or any suitable mechanism for interchange of an electronic document to a format better suited for interchange with device functions such as print 304, facsimile 306 or scan 308.

Finally, the job queue 312 is in data communication with a parser 318, which parser suitably fimctions to receive print job language files from an external device, such as client device services 322. The client device services 322 suitably include printing, facsimile transmission, or other suitable input of an electronic document for which handling by the controller function 300 is advantageous. The parser 318 functions to interpret a received electronic document file and relay it to the job queue 312 for handling in connection with the afore-described functionality and components.

In operation, image data encoded in a multidimensional color space is first acquired. Histogram data is then calculated in accordance with the acquired image data and a ramp zone associated with the calculated histogram data is detected. A black level associated with the acquired image data is then selectively stretched in accordance with the detected ramp zone so as to generate enhanced image data. The enhanced image data is then output to an associated data storage or an associated display.

According to one example embodiment of the subject application, image data encoded in a multidimensional color space, such as RGB, or the like, is first received by the controller 108 or other suitable component associated with the document processing device 104, by the user device 114, or by any other suitable processing device, as will be appreciated by those skilled in the art. The skilled artisan will further appreciate that while reference is made hereinafter to the controller 108 or other suitable component associated with the document processing device 104 implementing the subject application, other computing devices are equally capable of implementation of the system and method of the subject application. Acquisition of the input image data is capable of occurring via operations of the document processing device 104, e.g. scanning, facsimile, electronic mail, or the like, via an external device, e.g. a digital camera, via a portable storage device (not shown), via communication from a networked device, e.g. the user device 114, or the like. Following receipt of the input image data, a histogram is calculated and normalized by the total number of pixels in the input image, as will be understood by those skilled in the art.

An M-th order backward difference is then calculated from the normalized histogram data so as to generate difference data. In accordance with one embodiment of the subject application, a first order backward difference is applied to the calculated histogram data to generate the difference data. A ramp zone is then calculated in association with the histogram data by the controller 108 or other suitable component associated with the document processing device 104. Data corresponding to a property of the ramp zone is then acquired, e.g. ramp start, ramp stop, ramp length, or the like. The length of the detected ramp zone is then calculated from the zone property data.

A determination is then made whether the ramp start property begins at a predetermined threshold value (Th). When the ramp start has a value above the predetermined threshold value, e.g. ramp start >Th, black stretch is not applied to the input image. When it is determined that the ramp start property has a value below the predetermined value (Th), a second determination is made whether the ramp length exceeds a predetermined threshold value (Th′). In the event that the length of the ramp does not meet the predetermined threshold value, e.g. ramp length <Th′, black stretch is not applied to the input image. When the ramp length is above the predetermined threshold value, a third determination is made whether the histogram count at ramp start is below a predetermined threshold value (Th″). In the event that the histogram count at ramp start is above the predetermined threshold value, e.g. histogram count >Th ″, black stretch is not applied to the input image.

Upon the determinations that the ramp start occurs below the predetermined threshold value (ramp start <Th), that the ramp length exceeds the predetermined threshold value (ramp length >Th′), and that the histogram count at ramp start is below the predetermined threshold value (histogram count <Th″), the input image is tested so as to determine whether or not the input image represents a fog scene image, a partial fog scene image, or a tinted artistic scene image. The classification of the input image as a fog scene, partial fog scene, or tinted artistic scene is capable of being accomplished in accordance with the systems and methods set forth in U.S. patent application Ser. Nos. 11/851,160 and 12/039,225, the entirety of which are incorporated herein. Upon a determination that the input image is a fog scene, a partial fog scene, or a tinted artistic scene, black stretch is not applied to the input image data.

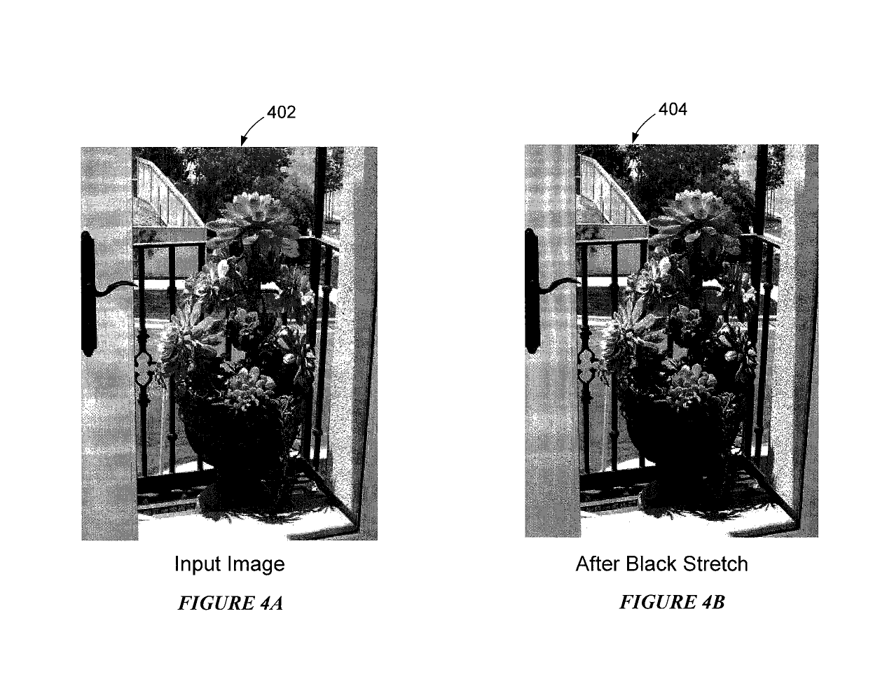

When the input image is determined not to be a fog scene, a partial fog scene, or a tinted artistic scene, an amount of black stretch (Delta) is calculated for application to the input image as a function of the ramp stop property. The calculation of the amount of black stretch (Delta) is discussed in greater detail below with respect to FIGS. 4A-19. Tone reproduction curve mapping is then applied, e.g. (Delta, 255) to (0, 255) to all pixels in the input image so as to generate enhanced image data. Thereafter, the enhanced image data is output to either an associated data storage, e.g. the data storage device 110, or an associated display, e.g. a user interface 106.

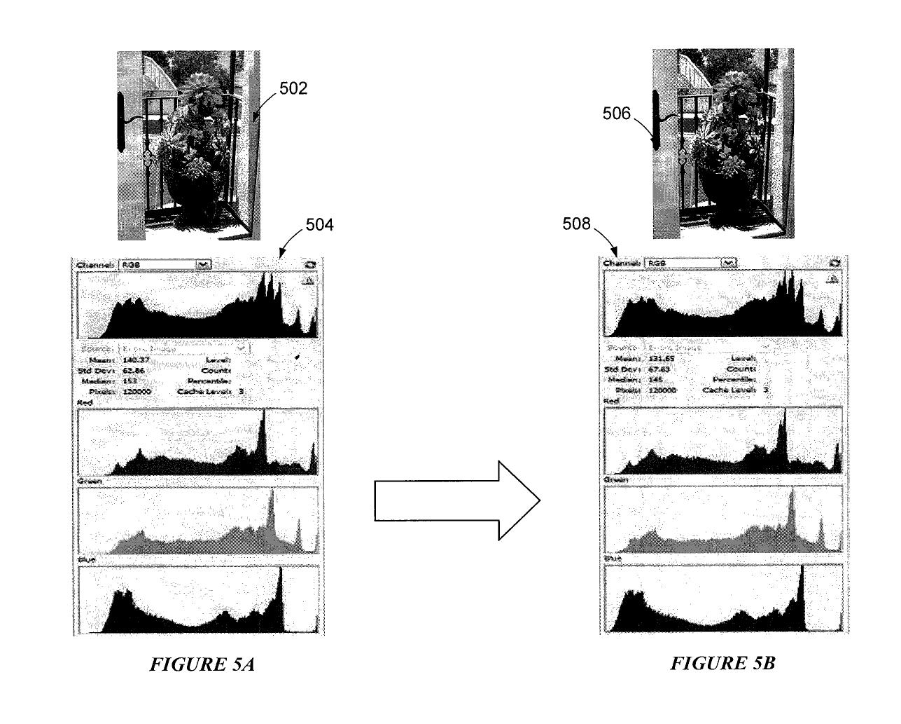

Turning now to FIGS. 4A-19, there are shown a plurality of images, histograms, and other examples corresponding to the implementation of the systems and methods of the subject application. FIG. 4A depicts an input image prior to the application of black stretch and FIG. 4B depicts the input image after black stretch application. FIG. 5A illustrates the input image 502 (the input image of FIG. 4A) and associated RGB histogram 504, and FIG. 5B illustrates the input image 506 and associated RGB histogram 508 after black stretch has been implemented. The skilled artisan will appreciate that black stretch corresponds, for example and without limitation, to holding the white end and stretching the other end toward black so as to utilize the full dynamic range. It will also be appreciated by those skilled in the art that such an example is the equivalent of mapping the 8-bit code values from (N, 255) to (0, 255), where N is a selected code value. The amount of black stretch, Delta, applied to the input image 502 is determined by the selection of N, the result of which application shown in FIGS. 4B and 5B.

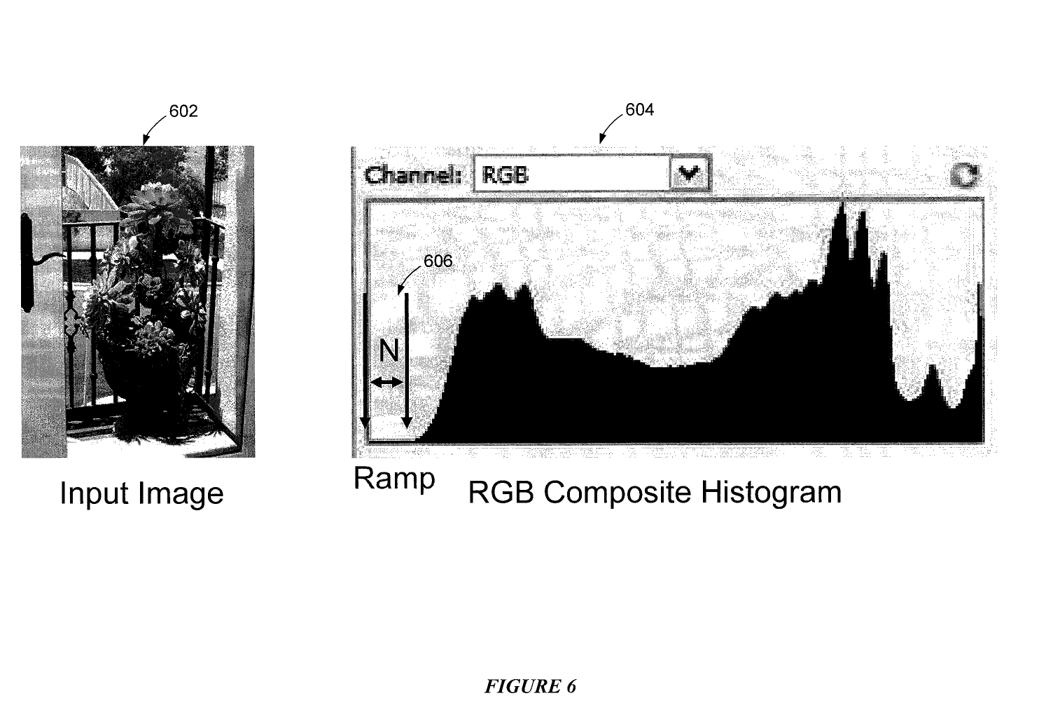

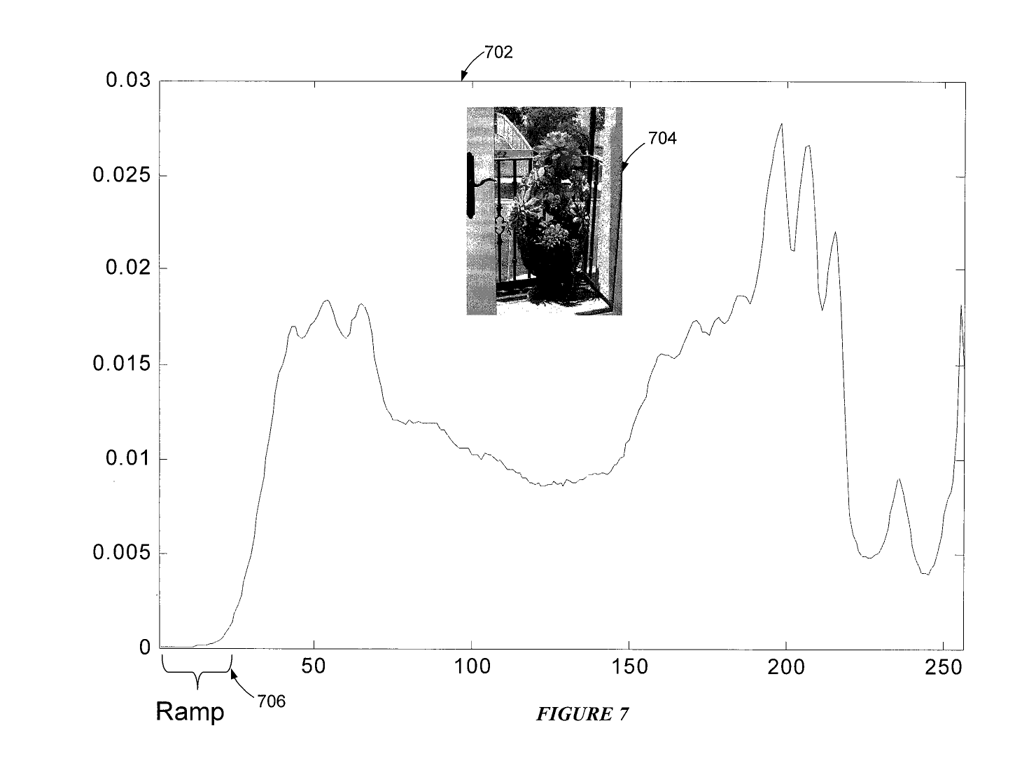

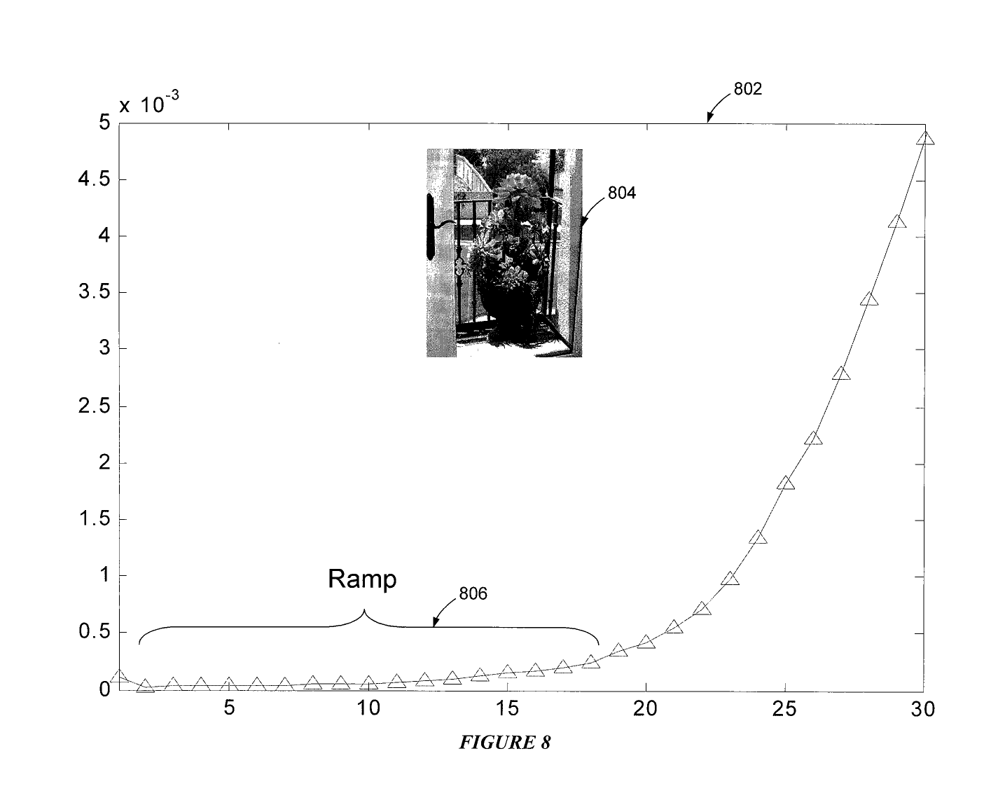

In accordance with one embodiment of the subject application, a determination is first made whether the input image 502 is in need of black stretch by analyzing the RGB histogram 504 so as to determine whether a “long ramp” towards the black end of the histogram is present. Turning now to FIG. 6, there is shown the input image 602 (corresponding to the input image of FIG. 4B and the input image 502 of FIG. 5B). FIG. 6 also depicts an RGB composite histogram 604, which illustrates the “long ramp” 606 referenced above. FIG. 7 shows an RGB histogram 702 corresponding to the input image 704 (input image of FIGS. 4A, 5A, and 6) normalized by the total number of pixels, with the “ramp” shown at 706. FIG. 8 illustrates a close up view of the “long ramp” 806 associated with the input image 804, such that the histogram 802 ramps up gradually from the dark end. The skilled artisan will appreciate that the subject application enables the detection of the existence of such a characteristic phenomenon in an RGB histogram of an associated image.

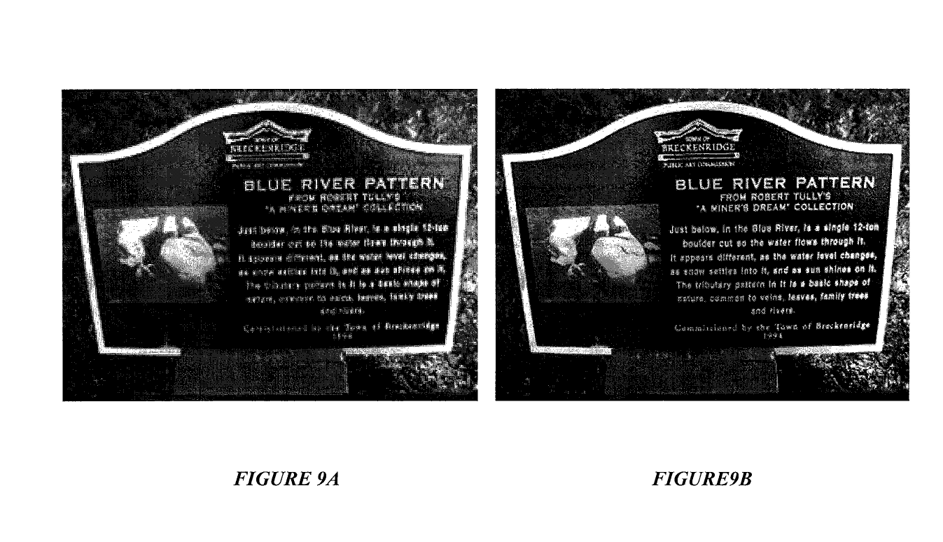

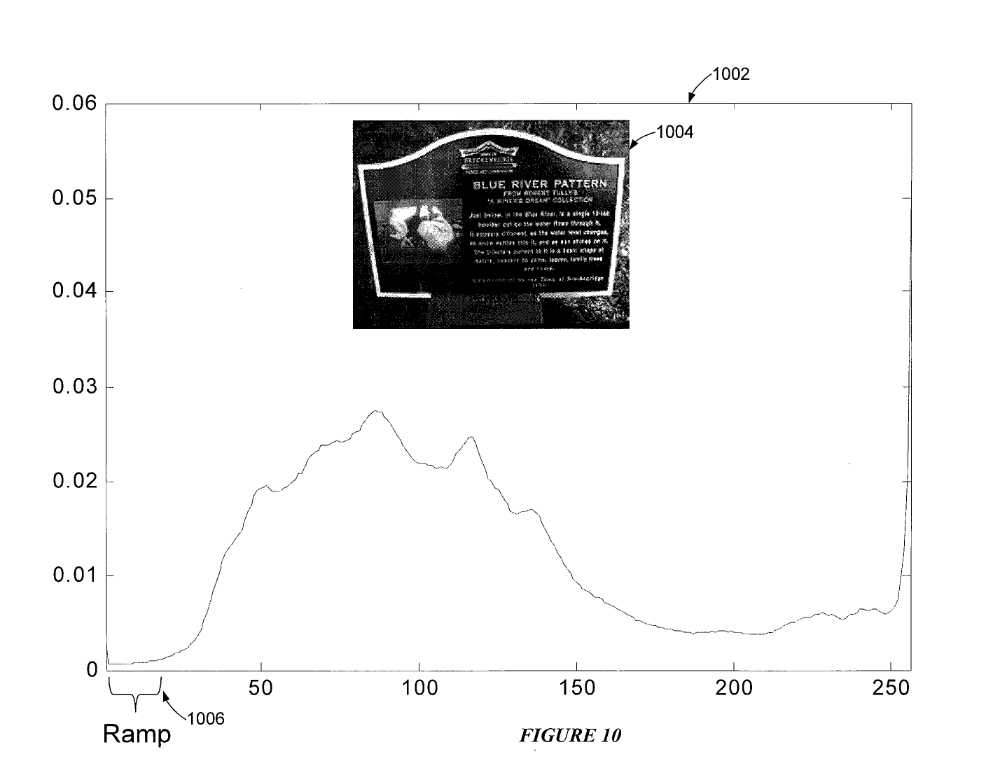

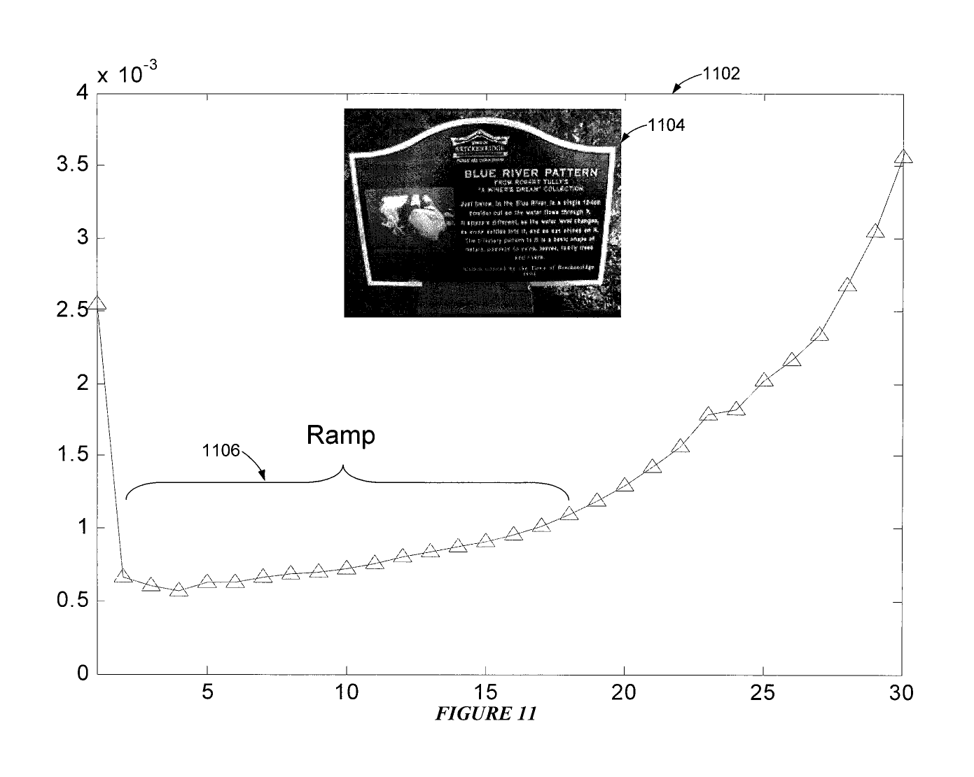

FIG. 9A and FIG. 9B illustrate a second example of an input image prior to black stretch (FIG. 9A) and the same image following black stretch (FIG. 9B). An RGB histogram 1002 calculated from the image 1004 is depicted in FIG. 10, which appears to show a suitable “long ramp” 1006. FIG. 11 depicts a close-up view of the histogram 1102, which reveals that, aside from a small spike at the dark end, the ramp 1106 does not always stay close to zero. The skilled artisan will appreciate that the image 1104 presents a problem in determining whether to apply black stretch. It will be understood by those skilled in the art that backward differencing is capable of being applied to the histogram 1102 so as to remedy the aforementioned problem. Preferably, a first order backward difference is suitably implemented so as to alleviate this problem. It will be appreciated by those skilled in the art that while a first order is sufficient, the subject application is also capable of implementing second order differencing, third order differencing, or the like.

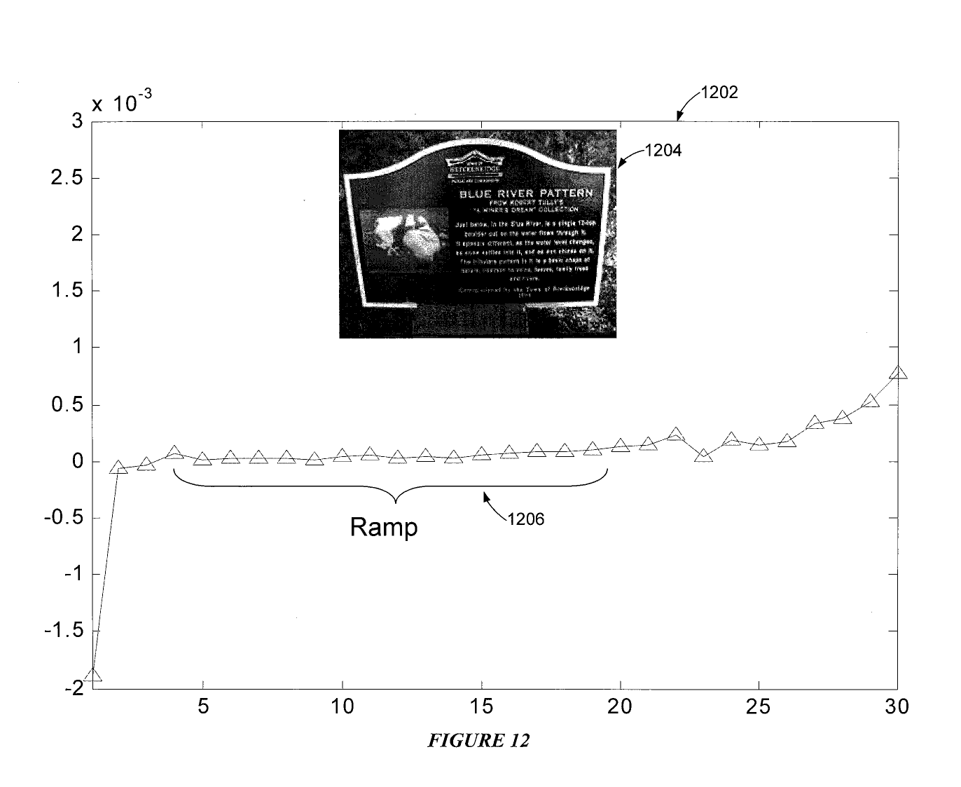

For example, if H is the RGB histogram of bin size 1, define H[i] as the histogram count at the i-th code value, e.g., H[1] is the number of pixels in the image with value 0 in 8-bit code values and H[128] is the number of pixels in the image with value 127 in 8-bit code values, and so on. Therefore, the first order backward difference is D[i]=H[i+1]-H[i]. FIG. 12 illustrates a close-up view of the histogram 1202 corresponding to the image 1204 having a “long ramp” 1206 after the application of the first order backward difference.

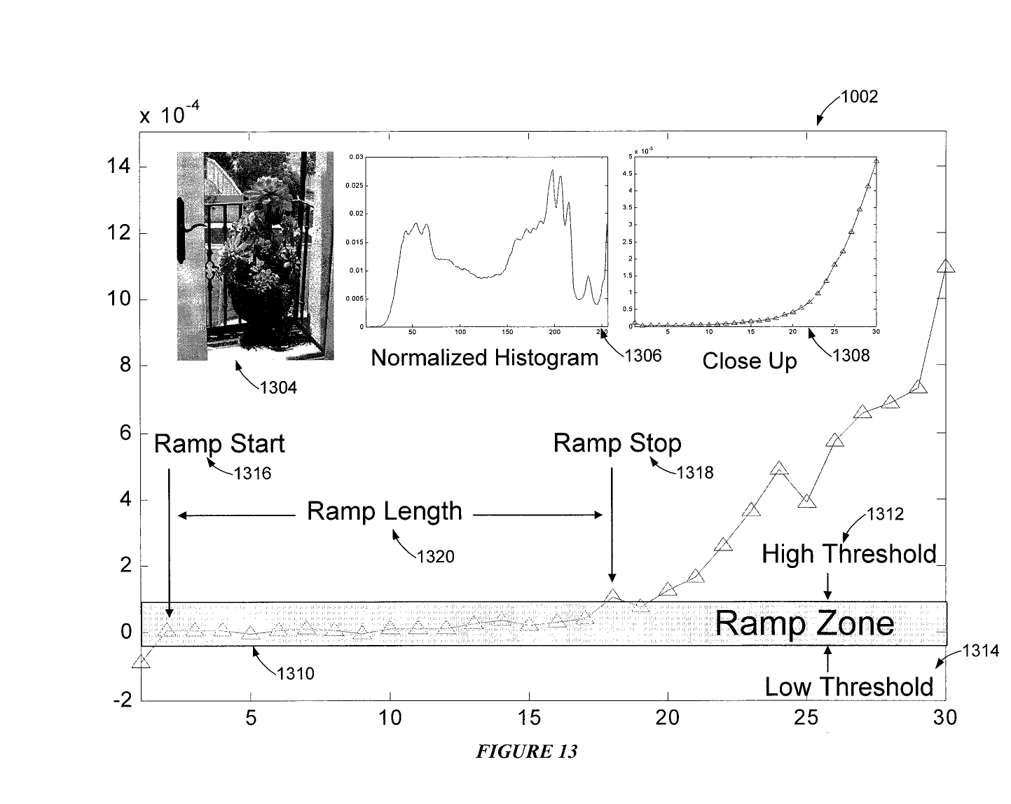

Turning now to FIG. 13, there is shown a normalized histogram 1302 with a first order backward difference applied. FIG. 13 also illustrates the associated input image 1304, normalized histogram 1306, and a close-up view of the ramp 1308. The histogram 1302 further depicts a ramp zone 1310 (shaded region) that is defined by the high threshold value (HT) 1312 and the low threshold value (LT) 1314. The skilled artisan will appreciate that by traversing from code value 0 upwards, the histogram 1302 enters the ramp zone 1310 at ramp start 1316 (approximately value 2) and exits the ramp zone 1310 at ramp stop 1318 (approximately code value 18). Thus, as shown in FIG. 13, a ramp length 1320 is calculated using the equation:

(ramp stop−ramp start)+1, e.g. ramp length=(18−2)+1, or ramp length of 17.

According to one example embodiment of the subject application, a ground truth is established via the selection of 500 sample images having typical ontology specific to the target application of black stretch, with suitable judgments made on associated image quality, necessary adjustments to improve image quality, amount of adjustments, and the like. It will be understood by those skilled in the art that the determined ground truth enables the identification of those images among the selected sample images that are in need of black stretch. The skilled artisan will therefore appreciate that the derivation of the HT 1312 and LT 1314 values, ramp start 1316 and ramp stop 1318 is suitably based upon the optimization of the rate on detecting images in need of black stretch.

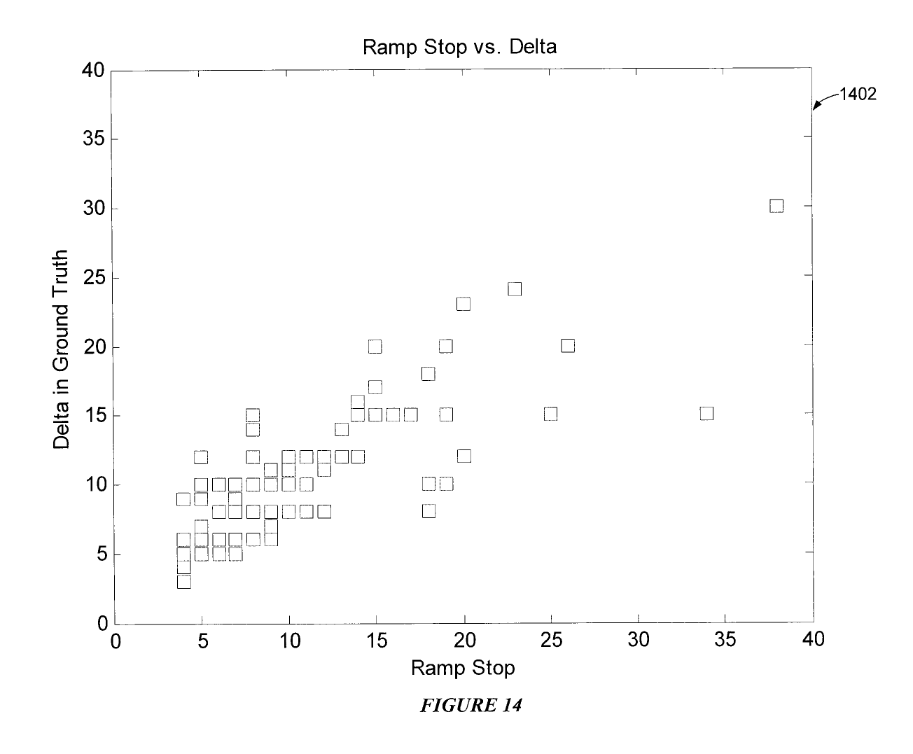

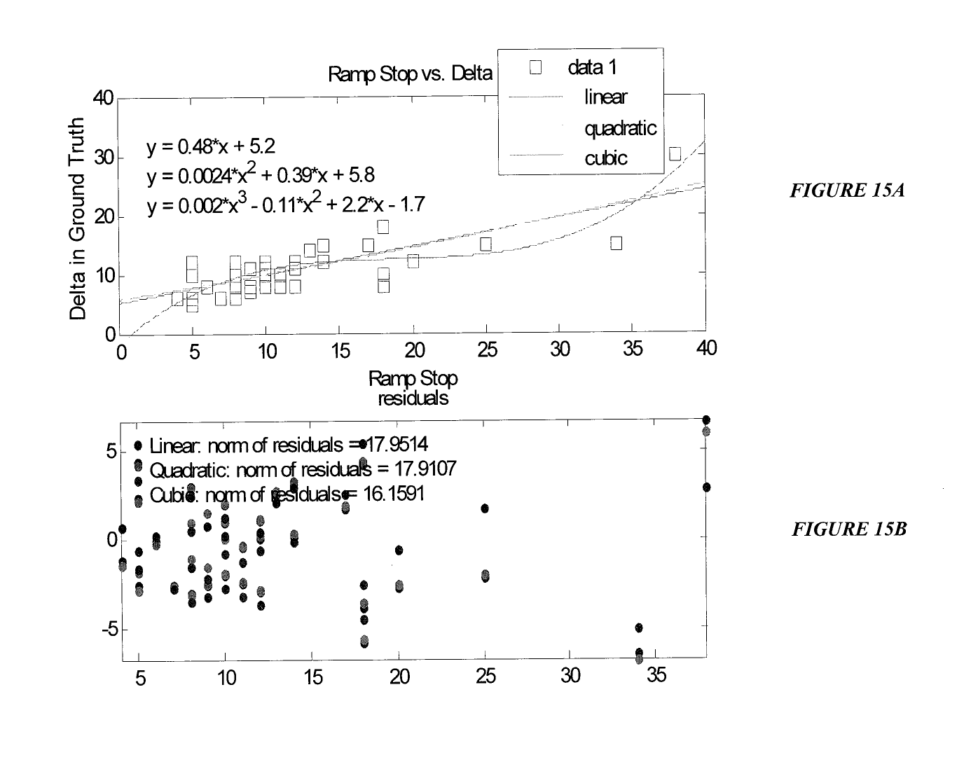

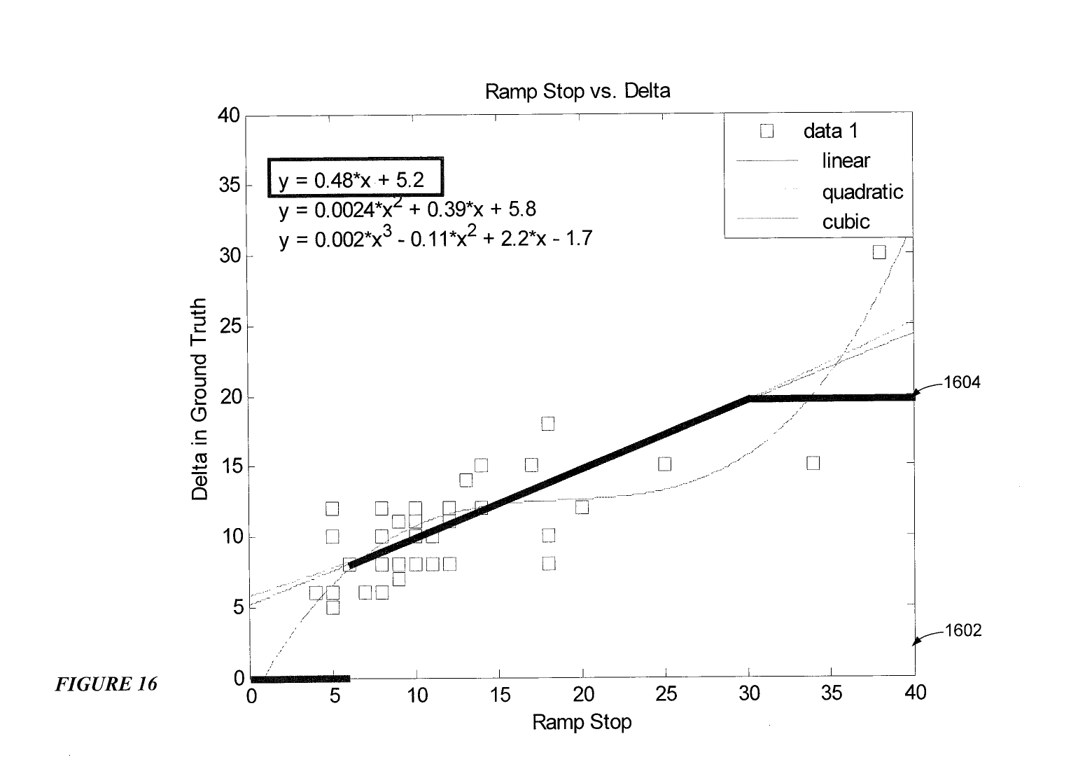

FIG. 14 illustrates an example plot 1402 of ramp stop and the amount of black stretch recorded in the ground truth. FIG. 15A illustrates the correlation between the ramp stop and amount of black stretch in ground truth in linear, quadratic and cubic fitting functions, and their norm of residuals (FIG. 15B). FIG. 16 illustrates a plot 1602 of a piece-wise linear fitting function 1604 for correlation in accordance with one embodiment of the subject application. As shown in FIG. 16, the amount of black stretch (Delta)=0.48*ramp stop+5.2 if ramp stop is between 6 and 30 while Delta is zero if ramp stop is less than 6, and Delta is 20 if ramp stop is greater than 30.

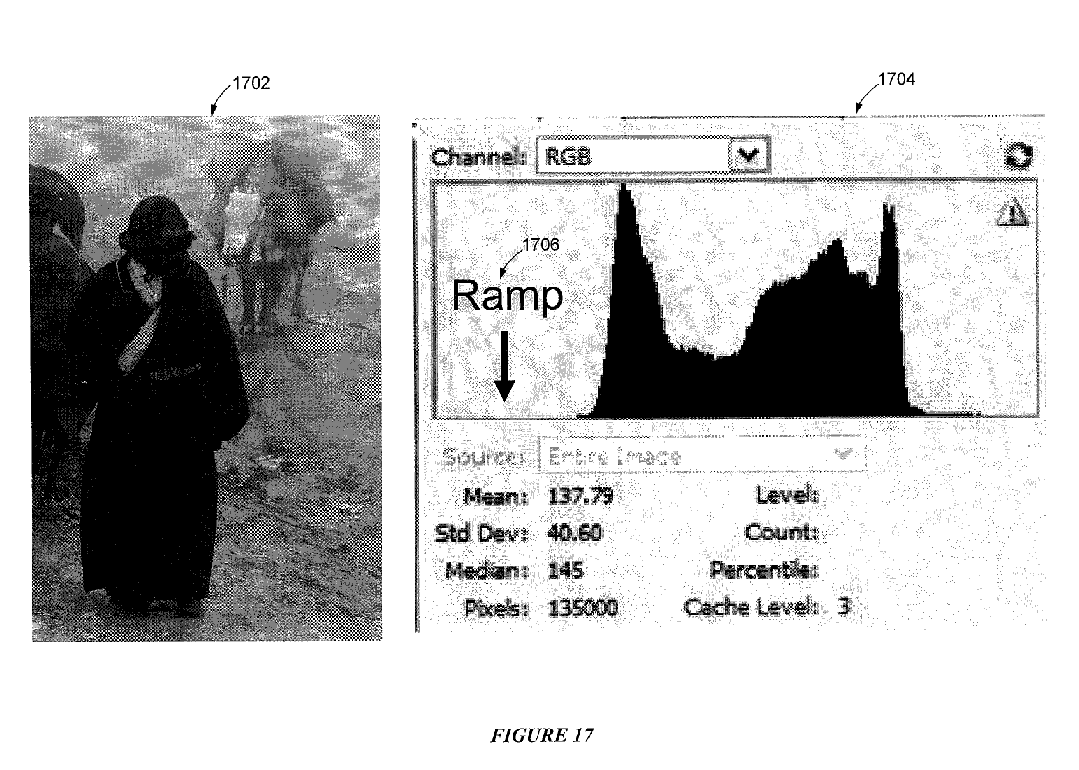

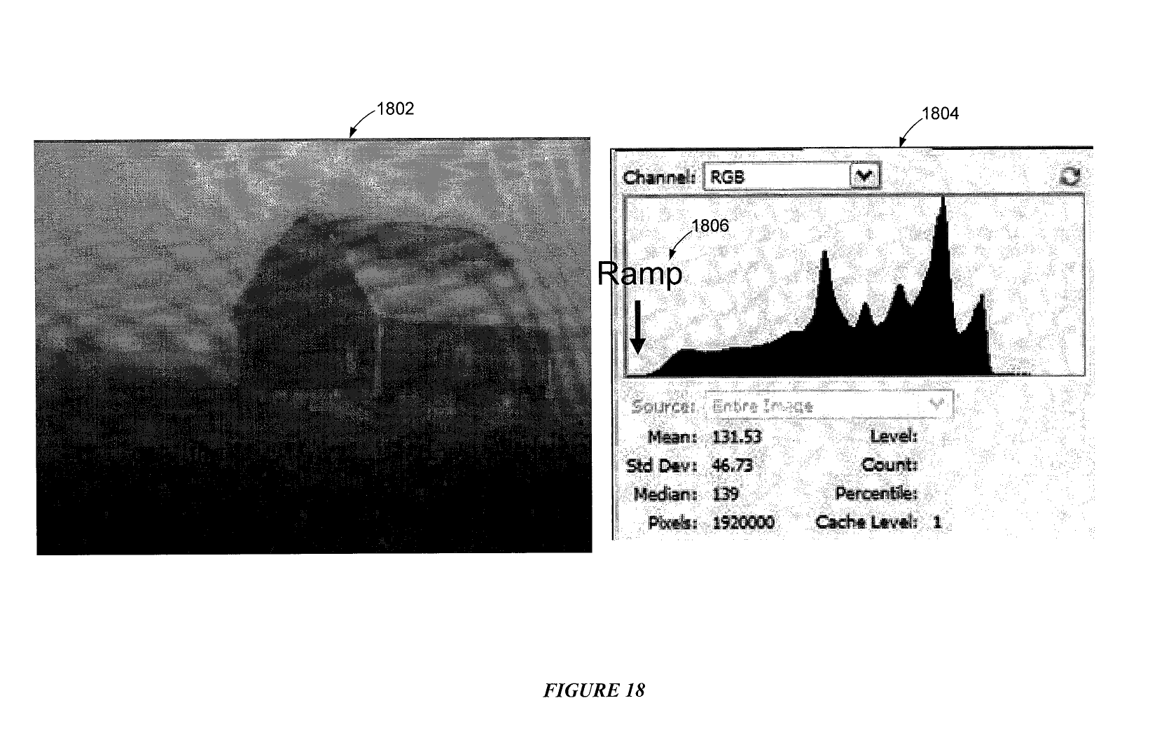

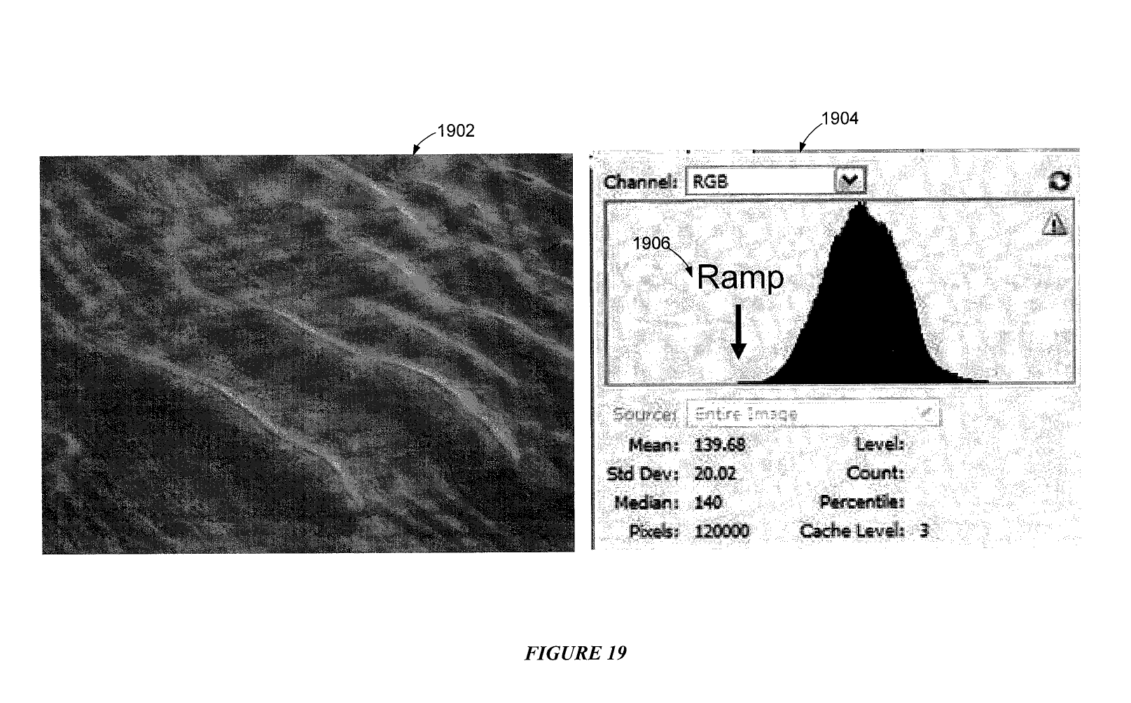

The skilled artisan will appreciate that there are several conditions in which black stretch should never be applied to an input image. A first false positive is illustrated in FIG. 17, which includes an input image 1702 and a normalized histogram 1704. As shown in FIG. 17, the normalized histogram 1704 includes a legitimate “long ramp” 1706, however black stretch is not applied in the ground truth as the input image 1702 corresponds to a fog scene image. A suitable system and method for determining whether an input image represents a fog scene image is found in U.S. patent application Ser. No. 11/851,160, the entirety of which is incorporated herein. A second false positive is illustrated in FIG. 18, which includes an input image 1802 and a corresponding normalized histogram 1804. The histogram 1804 does include a legitimate “long ramp” 1806 indicative of application of black stretch, but as the input image 1802 is a partial fog scene, black stretch was not applied in ground truth. A suitable system and method for determining whether an input image represents a partial fog scene image is found in U.S. patent application Ser. No. 11/851,160, the entirety of which is incorporated herein. FIG. 19 also depicts a false positive example of an input image 1902 and associated histogram 1904 having a legitimate “long ramp” 1906. Black stretch was not applied in ground truth to the input image 1902 as the input image 1902 is a tinted artistic scene. A suitable system and method for determining whether an input image represents a tinted artistic scene image is found in U.S. patent application Ser. No. 12/039,225, the entirety of which is incorporated herein. The skilled artisan will appreciate that black stretch is thus not applicable to fog scenes, partial fog scenes, or tinted artistic scenes.

Thus, the skilled artisan will appreciate that the forgoing examples illustrate the determination of whether or not to apply black stretch and if so, the amount of black stretch to apply to a received input image. Stated another way, following receipt of an input image, an RGB histogram is calculated and normalized by the total number of pixels. The histograms M-th order backward difference is then calculated. Next, the ramp start, ramp stop and ramp length with respect to ramp zone defined by high threshold value HT and low threshold value LT are calculated. Thereafter, if the “long ramp” (from the histogram) begins at a predetermined starting point, e.g., ramp start <Th; the “long ramp” exceeds a predetermined length, e.g., ramp length >Th′; and the histogram count at ramp start is below a predetermined threshold value, e.g., H[ramp start]<Th″, then the input image is determined to have a legitimate “long ramp”. When the input image does include a legitimate “long ramp” and it is not a fog scene, partial fog scene, or a tinted artistic scene, then black stretch is determined to be applicable to the input image.

The amount of black stretch, Delta, is then calculated as a function of the ramp stop. A Tone Reproduction Curve (TRC) is then calculated that maps (Delta, 255) to (0, 255) to all pixels in the input image. In accordance with one embodiment of the subject application, the TRC is used to build a lookup table, which is then applied to all pixels in the input image.

It will be appreciated by those skilled in the art that the ramp zone is capable of including a dead zone, wherein all code values are 0 in a region between 0 code value and some higher code value, e.g. images from digital cameras, scanners, or the like. Furthermore, at the higher end of the dead zone, a ramp is capable of being found in which the code values increase as per the illustration in FIGS. 6-13. The skilled artisan will also appreciate that black shifting of the dead zone to zero code value is not performed on special scene image types, e.g. fog, partial fog, artistic, and the like. In the event that the image does not represent a fog scene, partial fog scene, or artistic scene, the total shift includes the length of the dead zone, and in some circumstances, a portion of the ramp. The skilled artisan will appreciate that in such an embodiment of the subject application, the ramp determines is the degree of low code value clipping that will occur.

The skilled artisan will note that clipping in this dark region need not necessarily be problematic. For the most part, if the clipping is modest, it enhances the image, and in the case of a noisy image (e.g., caused by a high ISO setting on the digital camera and/or a long exposure), black point clipping is capable of reducing the apparent noise of an image. According to one particular example embodiment of the subject application, the parameters are optimized as follows: M=1, i.e., first order backward difference; HT=0.7E-4, LT=−1.3E-3 for ramp zone; and Th=3, Th′=2, and Th″=0.9E-3.

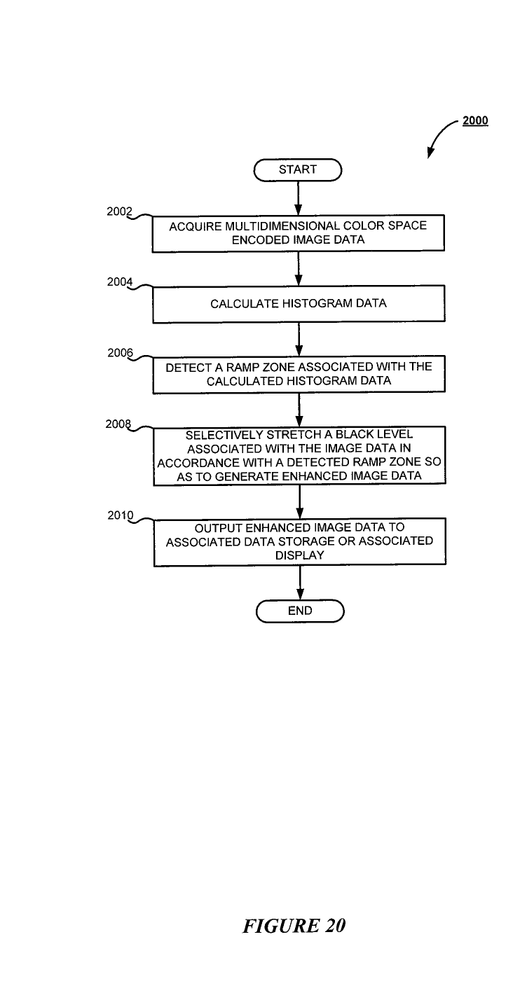

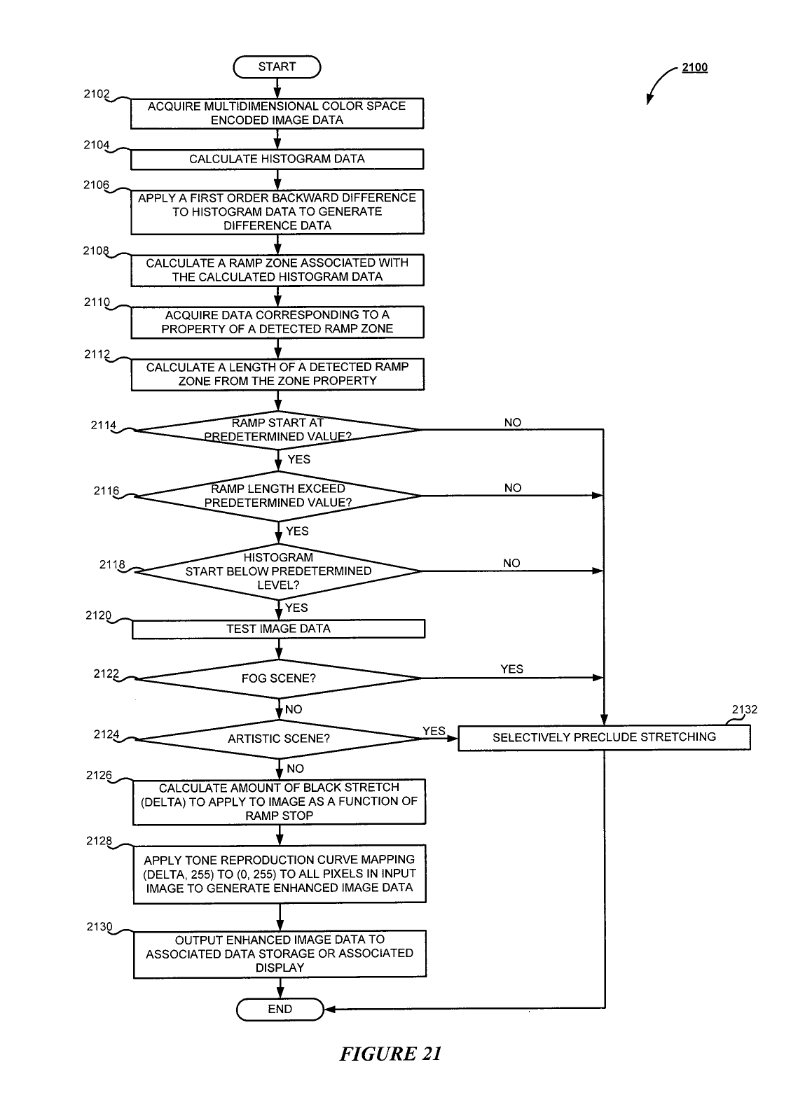

The skilled artisan will appreciate that the subject system 100 and components described above with respect to FIG. 1, FIG. 2, FIG. 3, FIG. 4, FIG. 5, FIG. 6, FIG. 7, FIG. 8, FIG. 9, FIG. 10, FIG. 11, FIG. 12, FIG. 13, FIG. 14, FIG. 15, FIG. 16, FIG. 17, FIG. 18, and FIG. 19 will be better understood in conjunction with the methodologies described hereinafter with respect to FIG. 20 and FIG. 21. Turning now to FIG. 20, there is shown a flowchart 2000 illustrating a method for global darkness image enhancement in accordance with one embodiment of the subject application. Beginning at step 2002, multidimensional color space encoded image data is first received by the controller 108 or other suitable component associated with the document processing device 104. It will be appreciated by those skilled in the art that the reference to the controller 108 with respect to FIG. 20 is for example purposes only, and the user device 114, or other suitable computing device is equally capable of implementing the methodology of FIG. 20.

At step 2004, histogram data is calculated in accordance with the acquired image data by the controller 108 or other suitable component associated with the document processing device 104. A ramp zone is then detected at step 2006 associated with the calculated histogram data. The skilled artisan will appreciate that the ramp zone is suitably illustrated in FIG. 13, discussed in greater detail above. At step 2008, a black level associated with the acquired image data is selectively stretched in accordance with a detected ramp zone so as to generate enhanced image data. The enhanced image data is then output at step 2010 to an associated data storage, e.g. data storage 110, or associated display, e.g. user interface 106. The skilled artisan will appreciate that when implemented via the user device 114, the enhanced image data is suitably capable of being stored on an internal hard disk of the user device 114, displayed via a display associated with the user device 114, communicated to a suitable network storage (not shown), or the like.

Referring now to FIG. 21, there is shown a flowchart 2100 illustrating a method for global darkness image enhancement in accordance with one embodiment of the subject application. The method depicted in FIG. 21 begins at step 2102, whereupon multidimensional color space encoded image data is acquired by the controller 108 or other suitable component associated with the document processing device 104. The acquisition of such image data is capable of occurring via an operation of the document processing device 104, via a portable data storage device, via the data storage device 110, via the user device 114, or the like. It will be appreciated by those skilled in the art that while reference is made hereinafter to the controller 108 or other suitable component associated with the document processing device 104 performing the methodology of FIG. 21, any suitable computing device, e.g. the user device 114, is capable of being implemented in accordance with the subject application.

At step 2104, the controller 108 or other suitable component associated with the document processing device 104 calculates histogram data from the acquired image data. According to one embodiment of the subject application, the histogram data is suitably normalized by the total number of pixels in the acquired input image, as will be understood by those skilled in the art. A first order backward difference is then applied to the calculated l0 histogram data at step 2106 so as to generate difference data. The controller 108 or other suitable component associated with the document processing device 104 then calculates a ramp zone at step 2108 associated with the calculated histogram data. A suitable example of the ramp zone determination is illustrated in FIG. 13, discussed in greater detail above.

Data corresponding to a property of the detected ramp zone is then acquired by the controller 108 or other suitable component associated with the document processing device 104 at step 2110. In accordance with one embodiment of the subject application, the detected ramp zone property includes, for example and without limitation, ramp start, ramp stop, ramp length, or the like. The length of the detected ramp zone is then calculated at step 2112 from the zone property. As set forth above, in accordance with one embodiment of the subject application, the ramp length is calculated by subtracting the ramp start from the ramp stop and adding one (ramp length=(ramp stop−ramp start)+1).

A determination is then made at step 2114 whether the ramp start value occurs below a predetermined threshold value (Th), i.e. whether ramp start <Th. When it is determined by the controller 108 or other suitable component associated with the document processing device 104 that the ramp start value is greater than the predetermined threshold value Th, black stretching is precluded at step 2132, whereupon operations terminate with respect to FIG. 21. Stated another way, when the ramp starts too late or not soon enough, black stretch is not appropriate for the acquired image data.

Upon a determination at step 2114 that the ramp start is less than Th, flow proceeds to step 2116. A determination is made at step 2116 whether the calculated ramp length exceeds a predetermined threshold value (Th′). That is, a determination is made whether ramp length >Th′. Upon a determination that the ramp length is less than the predetermined threshold value Th′, flow proceeds to step 2132, whereupon black stretch is precluded from application to the acquired image data and operations with respect to FIG. 21 terminate. A determination at step 2116 that the ramp length is greater than the threshold value Th′ prompts a subsequent determination at step 2118 whether the histogram count at ramp start is less than a predetermined threshold value (Th ″). In the event that the histogram count at ramp start is greater than the threshold value Th”, flow proceeds from step 2118 to step 2132, whereupon black stretching of the acquired image data is selectively precluded and operations of FIG. 21 terminate.

Upon a determination at step 2118 that the histogram count at ramp start is less than the threshold value Th″, flow proceeds to step 2120. At step 2120, the acquired image data is tested by the controller 108 or other suitable component associated with the document processing device 104. A determination is then made at step 2122 as to whether the acquired image data represents a fog scene image. In the event that the acquired image data is determined to represent a fog scene image or a partial fog scene image, flow proceeds to step 2132, whereupon black stretch is not applied to the acquired image data. Upon a determination at step 2122 that the acquired image data does not correspond to a fog scene image or a partial fog scene image, flow proceeds to step 2124. At step 2124, a determination is made whether the acquired image data corresponds to a tinted artistic scene image. If the acquired image data is determined to represent a tinted artistic scene image, flow proceeds to step 2132, whereupon black stretch is not applied to the acquired image data and operations with respect to FIG. 21 terminate. It will be appreciated by those skilled in the art that the testing performed at step 2120 facilitates the determinations made at steps 2122 and 2124 with respect to the type of image acquired. Preferably, the determination of fog scene, partial fog scene, or tinted artistic scene is accomplished in accordance with the methods and systems set forth in U.S. patent application Ser. Nos. 11/851,160 and 12/039,225, as referenced above.

Upon a determination at step 2124 that the acquired image data does not correspond to a tinted artistic scene image, flow proceeds to step 2126, whereupon the amount of black stretch (Delta) to be applied to the acquired image data is calculated as a function of the ramp stop property. In accordance with one example embodiment of the subject application, the calculation of the amount of black stretch is based upon a piece-wise linear fitting function for correlation: amount of black stretch, Delta=0.48*ramp stop+5.2 if ramp stop is between 6 and 30; Delta 0 if ramp stop is less than 6; and Delta=20 if ramp stop is greater than 30. The skilled artisan will appreciate that the preceding formulae are for example purposes only and not intended to limit the subject application thereto.

Once the amount of black stretch (Delta) has been calculated at step 2126, flow proceeds to step 2128. At step 2128, the controller 108 or other suitable component associated with the document processing device 104 applies tone reproduction curve mapping of (Delta, 255) to (0, 255) to all pixels in the acquired image data so as to generate enhanced image data. The enhanced image data is then output at step 2130 to an associated data storage, e.g. the data storage device 110, or an associated display, e.g. the user interface 106. The skilled artisan will appreciate that the methodology of FIG. 21 is capable of being performed by the user device 114, whereupon the enhanced image data is stored locally, e.g. an internal hard disk drive, RAM, or the like, or displayed via an associated display.

The foregoing description of a preferred embodiment of the subject application has been presented for purposes of illustration and description. It is not intended to be exhaustive or to limit the subject application to the precise form disclosed. Obvious modifications or variations are possible in light of the above teachings. The embodiment was chosen and described to provide the best illustration of the principles of the subject application and its practical application to thereby enable one of ordinary skill in the art to use the subject application in various embodiments and with various modifications as are suited to the particular use contemplated. All such modifications and variations are within the scope of the subject application as determined by the appended claims when interpreted in accordance with the breadth to which they are fairly, legally and equitably entitled.

What is claimed:

1. A global darkness image enhancement system comprising:
means adapted for acquiring image data encoded in a multidimensional color space;
means adapted for calculating histogram data in accordance with acquired image data;
means adapted for detecting a ramp zone associated with calculated histogram data;
enhancement means adapted for selectively stretching a black level associated with the acquired image data in accordance with a detected ramp zone so as to generate enhanced image data; and
means adapted for outputting enhanced image data to at least one of an associated data storage and an associated display.

2. The system of claim 1 further comprising:
testing means adapted for testing acquired image data to determine whether it is comprised of at least one of a fog scene and an artistic scene; and
means adapted for selectively precluding operation of the enhancement means when at least one of a fog scene and an artistic scene is indicated by the testing means.

3. The system of claim 1 further comprising means adapted for application of a first order backward difference to the histogram data so as to generate difference data therefrom.

4. The system of claim 3 further comprising means adapted for acquiring data corresponding to a property of a detected ramp zone, and wherein the enhancement means stretches the black level in accordance with a detected ramp zone property.

5. The system of claim 4 wherein the detected ramp zone property includes at least one of a ramp start, ramp stop, and ramp length property from a detected ramp zone.

6. The system of claim 5 further comprising:
means adapted for calculating a length of a detected ramp zone from the ramp zone property; and
means adapted for selectively precluding operation of the of the enhancement means in accordance with a calculated length of a detected ramp zone.

7. A global darkness image enhancement method comprising the steps:
acquiring image data encoded in a multidimensional color space;
calculating histogram data in accordance with acquired image data;
detecting a ramp zone associated with calculated histogram data;
lo selectively stretching a black level associated with the acquired image data in accordance with a detected ramp zone so as to generate enhanced image data; and
outputting enhanced image data to at least one of an associated data storage and an associated display.

8. The method of claim 7 further comprising the steps of:
testing acquired image data to determine whether it is comprised of at least one of a fog scene and an artistic scene; and
selectively precluding the selective stretching when at least one of a fog scene and an artistic scene is indicated by the testing step.

9. The method of claim 7 further comprising the step of applying of a first order backward difference to the histogram data so as to generate difference data therefrom.

10. The method of claim 9 further comprising the step of acquiring data corresponding to a property of a detected ramp zone, and wherein selective stretching of the black level is in accordance with a detected ramp zone property.

11. The method of claim 10 wherein the detected ramp zone property includes at least one of a ramp start, ramp stop, and ramp length property from a detected ramp zone.

12. The method of claim 11 further comprising the steps of:
calculating a length of a detected ramp zone from the ramp zone property; and
selectively precluding the black level stretching in accordance with a calculated length of a detected ramp zone.
